(19) United States
(12) Patent Application Publication
(10) Pub. No.: US 2015/0262258 A1
(43) Pub. Date: Sep. 17, 2015

(54) SYSTEM AND METHOD PUBLISHING AD HOC OFFER MESSAGES AND ANONYMOUS GEOGRAPHIC PROXIMITY AND CATEGORY SEARCHES

(71) Applicant: SMARTGEN LLC, Lewes, DE (US)

(72) Inventor: Maryam SCHONBECK, Lake Oswego, OR (US)

(21) Appl. No.: 14/621,539

(22) Filed: Feb. 13, 2015

(30) Foreign Application Priority Data
Mar. 17, 2014 (MC) 2597

(51) Int. Cl. G06Q 30/02

(52) U.S. Cl. CPC G06Q 30/0276; G06Q 30/0256; G06Q 30/0259; G06Q 30/0261; G06Q 30/0264; G06Q 30/0272

(57) ABSTRACT

An Internet-based system and method, allowing vendors to publish and transmit ad hoc offer messages that targets consumers with exceptional efficiency, and further allowing consumers to anonymously search such published offer messages based on geographic proximity and desired subject category, includes a vendor computer device, a system server operatively connected to the vendor computer device via a network, and a consumer computer device operatively connected to the system server via the network, where the consumer selects the search distance from the consumer's location, and one or more desired subject categories to be searched for searching a compilation of published offer messages hosted on the system server.

### BACKGROUND OF THE INVENTION

The invention provides an Internet-based system and method allowing vendors (retailers, restaurants, hotels) to publish ad hoc and targeted offer messages without prior gathering and storage of information regarding consumers, and allowing consumers (customers/buyers) to anonymously search these published offer messages based on geographic proximity and subject category, without requiring the consumer to share any personal information.

### DESCRIPTION OF THE RELATED ART

Various on-line systems exist that allow vendors to advertise to potential consumers (buyers).

A significant disadvantage of these systems is that they rely on the vendors and consumers to first establish a relationship (e.g., consumers having to sign up on a list maintained by vendor) and require the consumers provide personal information necessary for the vendors to communicate with the consumers, and understand the consumers' needs.

Another disadvantage of these systems is that i) vendors are required to guess what the consumer is interested in purchasing and, ii) even when the advertisements correspond with the consumer's needs, the timing may not coincide with the consumer's readiness to buy, thus rendering the advertisement useless (e.g., sending advertisements for televisions responsive to the consumer's searching for televisions in their browser or visiting websites selling televisions, while the consumer has already found and purchased a television and is no longer interested in them).

Further, these systems do not lend themselves to ad hoc real-time, short-term offers.

### SUMMARY OF THE INVENTION

The invention addresses such problems in the prior art.

In one or more embodiments, the invention comprises a method for providing ad hoc offer messages and anonymous geographic proximity and category searches, including steps of a geographically located vendor, via a vendor computer device, i) inputting an offer message describing an offer of a product or service being made by the vendor, ii) placing the offer message within an appropriate subject category by selecting one subject category, from a selection of plural subject categories, that describes the product or service being offered by the vendor, iii) selecting a time period for publishing the offer message, iv) selecting a publish time for beginning the publishing of the offer message, the selected publish time being one of a) immediately and b) a specific time at which the offer message will be published, and v) executing a send command that transmits an offer message package to a system server, the system server operatively connected to the vendor computer device via a communication network, the offer message package comprising the offer message, the selected subject category, the selected time period for publishing the offer message, and the publish time for beginning the publishing of the offer message;

the system server receiving, via the network, the offer message package sent from the vendor computer device and, beginning at the selected publish time and for the selected time period, adding the offer message of the received offer message package to a compilation of published offer messages hosted on the system server, the system server removing the offer message from the compilation of published offer messages upon expiration of the selected time period;

a consumer, via a consumer computer device operatively connected to the system server via the network, i) selecting a search distance, and ii) selecting, a desired subject category to be searched, from the selection of plural subject categories, that describes a product or a service desired by the consumer, and iii) executing a search command that transmits the selected search distance, the selected desired subject category, and a location of the consumer computer device to the system server;

the system server i) using the selected search distance and the location of the consumer computer device to determine a geographic search region, ii) using the selected desired subject category and the determined geographic search region to search the compilation of published offer messages hosted on the system server for a set of published offer messages that satisfies the determined geographic search region and the selected subject category, and iii) transmitting the set of published offer messages that satisfies the determined geographic search region and the selected desired subject category to the consumer computer device; and

displaying, on the consumer computer device, the transmitted set of published offer messages that satisfies the determined geographic search region and the selected desired subject category.

In one or more embodiments of the invention, the vendor computer device is any of a smart phone, a network-connected tablet, or a network-connected personal computer, and the consumer computer device is another smart phone, network-connected tablet, or network-connected personal computer.

In one or more embodiments of the invention, the search distance is selected from a set of distances corresponding to, for example, walking distance, biking distance, or driving distance, such as (but not limited to) ¼ mile, ½ mile, 1 mile, 5 miles, 50 miles, and 100 miles. Additionally, the consumer can, in one or more embodiments, input an arbitrary, ad hoc distance, such as 1,000 yards, or 3.5 miles.

In one or more embodiments of the invention, the subject category is selected from a group comprising (but not limited to) restaurants, cinemas, clothing stores, hotels, bakeries, and supermarkets.

In one or more embodiments of the invention, the selected publish time of the offer message is immediate upon transmitting the offer message package to the system server.

In one or more embodiments of the invention, the selected publish time of the offer message is at i) a specified future time, or ii) a specified future date and time.

In one or more embodiments of the invention, when the vendor removes the received offer message from the compilation of published offer messages, the removed offer message is immediately deleted from the consumer device.

One or more embodiments of the invention include a step of the vendor, via the vendor computer device, selecting a published offer message package, having a future publish time, to be deleted, and transmitting a delete message to the server identifying the published offer message to be deleted, whereupon the server, upon receiving the delete message transmitted from the vendor computer device, removes the published offer message to be deleted from the compilation of published offer messages on the system server, whereupon the published offer message to be deleted is immediately deleted from the consumer device.

In one or more embodiments of the invention, the location of the consumer computer device is determined by automatically retrieving location information from a geolocation device in connection with the consumer computer device. Direct input of the location information by the consumer is also supported.

In one or more embodiments of the invention, when the vendor removes the received offer message from the compilation of published offer messages, the removed offer message is immediately deleted from the consumer device.

In one or more embodiments of the invention, the vendor can edit a published message or messages, and the corresponding message(s) displayed on the consumer device will immediately update to reflect the edit applied by the vendor. For example, an inbox interface on the consumer device for displaying the published message(s) of the vendor(s) is automatically refreshed at a predetermined frequency (e.g., every second, every 5 seconds, or every 30 seconds).

In one or more embodiments of the invention, the consumer can operate the consumer device to remove from the inbox any individual message that they are not interested in.

The invention may also be embodied as one or more computer readable mediums having stored thereon computer executable code assembled as one or more computer program that, upon execution on one or more computer systems, execute the steps described above.

For example, in one or more embodiments of the invention, a non-transitory computer readable medium has stored thereon a computer executable code assembled as a computer program that, upon execution on a computer system, causes the computer system to perform a method of publishing and transmitting ad hoc offer messages and anonymous geographic proximity and category searches, the method comprising the steps of:

making available one or more ports on one or more network interfaces of the computer system operatively connected to one or more networks for receiving communications from a network-connected vendor computer device of a geographically located vendor and a network-connected consumer computer device;

receiving from the vendor computer device, via any of the one or more networks, an offer message package comprising an offer message, a selected subject category that describes a product or service being offered by the vendor, a selected time period for publishing the offer message, and a publish time for beginning the publishing of the offer message, the selected publish time being one of a) immediately and b) a specific time at which the offer message will be published;

beginning at the selected publish time and for the selected time period, adding the offer message of the received offer message package to a compilation of published offer messages hosted on the computer system;

removing the offer message from the compilation of published offer messages upon expiration of the selected time period;

receiving from the consumer computer device, via any of the one or more networks, a search command that includes a search distance, a selected desired subject category, and a location of the consumer computer device;

using the selected search distance and the location of the consumer computer device to determine a geographic search region;

using the selected desired subject category and the determined geographic search region to search the compilation of published offer messages hosted on the system server for a set of published offer messages that satisfies the determined geographic search region and the selected subject category;

transmitting the set of published offer messages that satisfies the determined geographic search region and the selected desired subject category to the consumer computer device to be displayed on the consumer computer device.

The invention also comprises embodiments wherein non-transitory computer readable mediums have recorded thereon computer programs suitable for the vendor computer device and the consumer computer device, respectively, in accordance with the figures and description herewith.

The invention enables vendors (for example, retailers, restaurants, and hotels) to make and publish offer messages on an ad hoc basis without first establishing a database of existing or registered consumers and their needs and interests. These offer messages may be in the form of a simple offer message, or of a more complex, detailed form.

The invention also enables a consumer, via a configured computing device such as a smart phone, to selectively search for the published offer messages without providing personal information, thereby remaining anonymous and private.

A system server in accordance with the invention is configured to host and forward the vendors' published offer messages, thereby making these offer messages available to the consumers for anonymous search and selection.

The invention may be embodied as a non-transitory computer readable medium having stored thereon a computer executable program, which when executed by a processing unit of a computer system causes the computer system to perform the inventive method of publishing the ad hoc offer messages, as well as performing anonymous geographic proximity and category searches. With these features, the invention enables vendors to optimize sales and advertise by targeting consumers with exceptional efficiency, whereas consumers (that is, customers, buyers) save money and find nearby products and services promoted by a plurality of local vendors without having to pre-register and share personal information with any vendor.

Thus, the invention provides exceptional efficiency in targeting consumers, where consumers need not share personal info (e.g., email addresses, names or telephone numbers), need not log in, and vendors need not maintain an established database of existing or registered consumers with their needs and interests.

In accordance with the invention, geographically located vendors transmit their offer messages to a system server, via a commonly available network (e.g., the Internet), directly by means of a dedicated application or via an interface provided by a website, enabling the vendors to write and submit messages with offers for goods and/or services at any time, on demand. Such offers may be, for example, promotions for free goods or services, or goods or services at reduced prices, limited in duration (time period) and/or quantity. The vendor associates each offer message with an appropriate subject category provided by the system server. The vendor's geographic location is known to the system server.

Also in accordance with the invention, consumers, via the configured computing device in communication with the system server, are provided with a search capability to search for the published offer messages based on geographic proximity of the consumer to the vendor, and subject category of the products/services of interest to the consumer. As a particular feature of the invention, the consumer is not required to provide identification or personal information, e.g., the consumer's email address, name or telephone number, to the server in order to perform the search. The subject categories may include multiple categories including, but not limited to, restaurants, cinemas, clothing stores, hotels, supermarkets, boutiques, and salons. The subject categories can of course be adapted as needed by each vendor.

The subject categories allow consumers to easily access published offer messages on portable computing devices such as smart phones and tablets having Internet access while traveling. Particularly in consideration of such devices having GPS or other location-sensing capabilities, the invention considers the location of the device with the location of vendors in the search so that offers from vendors that are too far away are screened out, thereby reducing the number of offers likely not to be of interest the consumer performing the search. For example, limiting the geographic proximity of the consumer to the vendor eliminates vendors too far/remote from the consumer. However, if a consumer's computer device does not have an inherent geolocation capability, it is within the scope of the invention that such information is entered manually by the consumer along with the subject category.

A preferred embodiment of the invention also considers whether movement is detected by the portable device, indicating whether the consumer is travelling, e.g., on foot, and therefore may only be willing to do business with vendors within a limited distance (e.g., ⅛ or ¼ mile). The consumer may also expressly dictate a distance from the consumer's current location that he or she is willing to travel to reach a vendor having a published offer.

With the invention, vendors readily communicate with potential buyers within a predetermined geographic proximity, sending the offer messages to the system server to thereby make the offer messages available to an unlimited number of potential buyers rather than a number limited to a predetermined client list, with the offer messages being publishable to consumers at any time but, when desired, limited to a short term (time period).

This enables vendors the opportunity to offer promotions, sales, services and free or discounted goods on an on-demand basis, and thereby e.g. increase turnover and/or avoid spoilage. For example, a restaurateur who is left with empty tables at dinner time or an excess of a spoilable product can publish last minute offers to consumers located close by. This provides exceptionally effective targeting to buyers/clients that are in proximity of the vendor and interested in the vendor's product or services.

Likewise, consumers are provided with meaningful access in time and geographic space to current offers of vendors within an acceptable distance from the consumer. The invention thereby makes these offers between the vendors and consumers more efficient and easily accessible for both the vendors and consumers.

Through the invention, vendors not only effectively and timely address potential buyers, vendors are given an opportunity to try to make last minute sales they could not do otherwise, while allowing in parallel buyers to receive offers they would not have otherwise received. For example, a restaurant, bar, cinema or hotel, having empty seats or rooms, can send a last minute offer to all those that are geographically close to its activity to attract them and fill the empty seats.

### BRIEF DESCRIPTION OF THE DRAWING FIGURES

FIG. 1 a schematic of the inventive system.

FIG. 2 illustrates a non-limiting example of vendors and consumers distributed about an exemplary geographical area

FIG. 3 provides an overview flowchart.

FIG. 4 is an example vendor's incomplete offer screen.

FIG. 5 is an example vendor's category selection screen.

FIG. 6 is an example vendor's time period selection screen.

FIG. 7 is an example of a completed vendor's offer screen for a first offer.

FIG. 8 is an example of a vendor's outbox screen showing a completed offer submitted to the server.

FIG. 9 is an example of a vendor's incomplete offer screen for submitting preparing another offer, wherein a time for publishing the promotion in the future is being selected.

FIG. 10 is an example of a completed vendor's offer screen for the second offer.

FIG. 11 is an example of a vendor's outbox screen showing two completed offers submitted to the server.

FIG. 12 is an example of a consumer's screen showing an interface for selecting categories of interest and a search distance from the consumer's present location.

FIG. 13 is an example of a consumer's screen showing published offers meeting the consumer's search criteria.

FIG. 14 is an example of a consumer's screen showing a route from the consumer's location to a vendor with a published offer published meeting the consumer's search criteria.

FIG. 15 is an example of a consumer's screen presenting an interface of initiating a phone call to a vendor with a published offer meeting the consumer's search criteria.

FIG. 16 illustrates the consumer's inbox with valid offer messages returned from the consumer's search criteria.

### DETAILED DESCRIPTION OF THE INVENTION

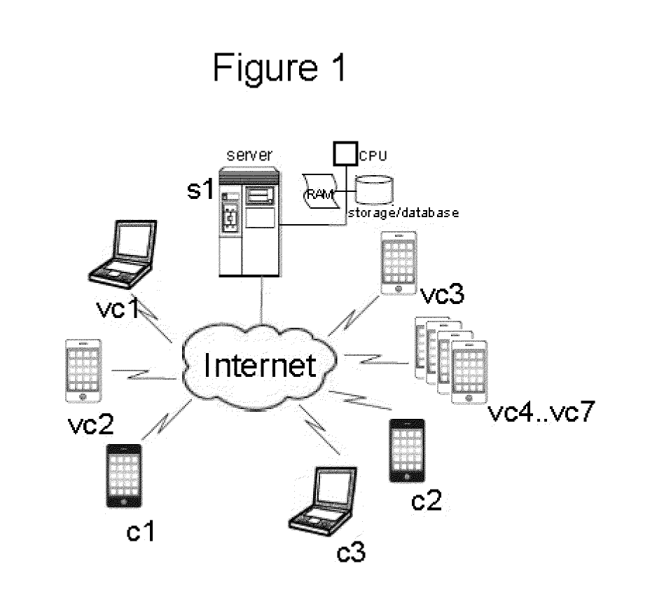

In a non-limiting exemplary embodiment of the invention, a system comprises at least a computer-executable program that operates on a computer server s1 (“server”), as shown in the diagram in FIG. 1. The computer server may be embodied as a single computer device or may comprise a plurality of redundant computer devices that operate to operate in place of one another in the event that one or more unexpectedly stop functioning.

A typical server s1 in accordance with the invention comprises at least a central processing unit (CPU), one or more volatile memory devices (e.g., random access memory or “RAM”), and one or more non-volatile memory storage devices (e.g., a hard disk drive, solid state drive, disk storage array, etc.) any of which may store data as files in a file system, as tables and rows in a relational database, or any equivalent. The server s1 also comprises a network interface enabling the server, in accordance with commands executed by the CPU, to communicate over a data network with other computer devices. In the present example, the network would be the Internet, being the most widely distributed and commonly available data network in use today.

In accordance with this embodiment of the invention, vendors v1 . . . v7 wishing to promote their goods or services through the inventive system interact with the server s1 via one or more computer devices, diagrammatically illustrated in FIG. 1. In the example here, each vendor's computer device vc1 . . . vc7 is connected to the server s1 via the Internet via a wireless connection, although any connection between any of these devices vc1 . . . vc7 to the Internet could just as easily be via a cable. Each vendor v1 . . . v7 interacts with the server s1 with his or her own computer device vc1 . . . vc7, but any vendor may use any suitable computer device provided it is configured to communicate with the server s1.

A vendor's computer device may be any suitable computer device capable of communicating with the server s1 via the Internet. Such a device may include any of a portable telephone having a Internet communication capability (e.g., a “smart phone”, iPhone®, Android® phone, etc.), a portable computing tablet having Internet communication capability (e.g., iPad®, Galaxy Tab®, etc.), or a network-capable personal computer, any of which may be in communication with the Internet via a wired connection or a wireless technology.

In accordance with the instant example, a vendor v1 activates a computer device vc1 and establishes a connection with the server s1. Although not limited to such, a particularly preferred embodiment has the vendor v1 using a web browser program (e.g., Google® Chrome®, Mozilla® Firefox®, Apple®, Safari®, or any equivalent) operating on the computer device vc1 to connect with the server s1 with a communications protocol such as hypertext transfer protocol (HTTP), secure hypertext transfer protocol (HTTPS), or any equivalent.

As a non-limiting alternative, a computer program operating on the computer device vc1 expressly designed to communicate and interact with the server s1 (i.e., an application, commonly called an “app”) may be used in place of the web browser.

The server s1 maintains records, in the non-volatile storage of the server s1, of registered vendors having permission to use the inventive system. Records of the vendors include information for use in authenticating each vendor in order to prevent unauthorized use of the system. Records of each vendor also include at least geographical information of the vendor's place of business. Such records may also include contact information for the vendor's place of business, hours of operation of the business, and other useful data.

To interact with the system, the vendor v1 begins by establishing contact between the vendor computer device vc1 and the server s1, and then authenticating his or herself with the server s1. This may typically comprise (but is not limited to) entering and transmitting to the server s1 a username and password sufficient to log in to the inventive system operating on the server s1. Other examples of authentication for logging into the server s1 include, but are not limited to, providing biometric data, financial credentials, interfacing an electronic authentication device with the vendor computer vc1, or any reasonable equivalent.

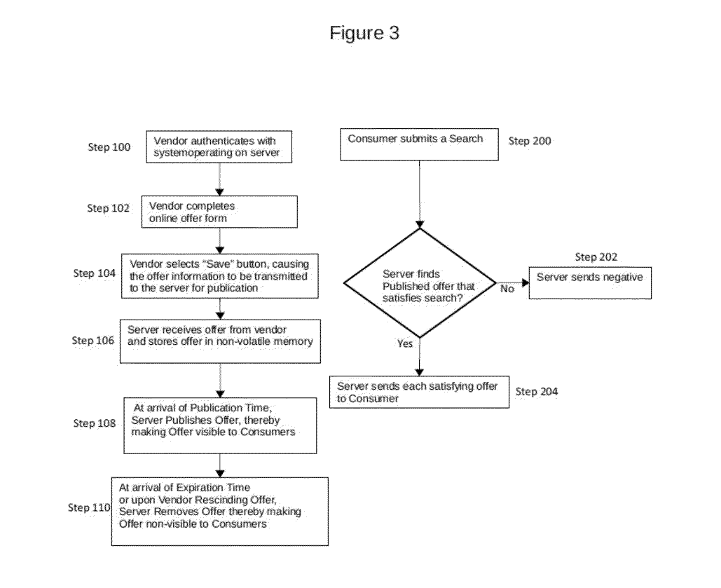

After logging into the system operating on the server s1 (step 100, FIG. 3), a vendor v1, having a geographical location associated therewith, completes the form displayed on the display device of the vendor computer device vc1 in accordance with commands transmitted to the vendor computer device vc1 by the server s1 (step 102, FIG. 3).

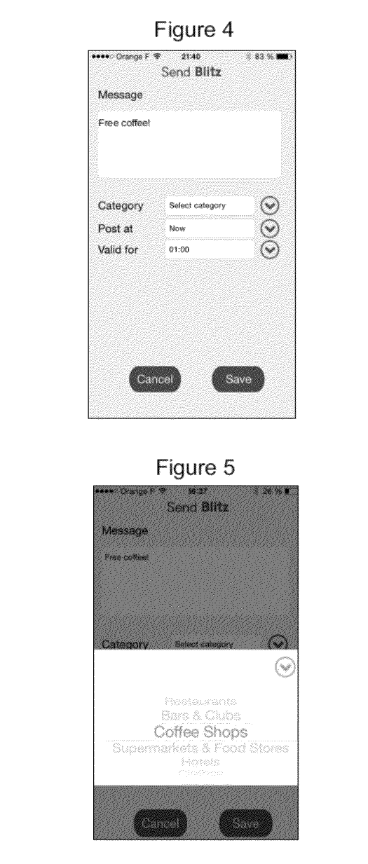

An exemplary form is shown in FIG. 3. The vendor v1 types and offer message concerning the new offer being made (“Free coffee!”, FIG. 4). Next, as shown in FIG. 5, the vendor selects an appropriate subject category (here, “Coffee Shops”).

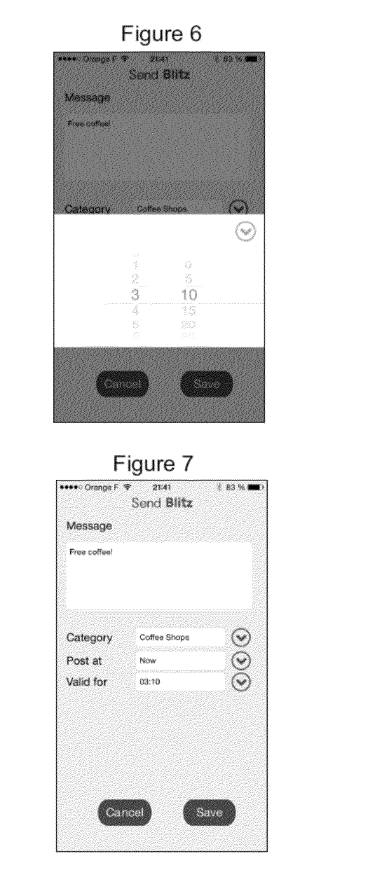

The vendor can also select how long the promotion is to last before it automatically expires. In the non-limiting example shown in FIG. 6, the vendor selects 3 hours 10 minutes from a selection interface. FIG. 7 shows an example of a completed interface, ready to be submitted to the server via activating the “Save” button which causes the vendor's computer device vc1 to transmit the offer message package, including the offer message, the subject category, and the time information, to the server s1, thereby Step 104 of the flow chart of FIG. 3. Alternatively, the operation may be canceled by activating the “Cancel” button, whereupon no information for submitting a new offer is transmitted to the server s1.

In one or more embodiments, the published message offers sent by the server to the consumer may be any suitable form that does not require any kind of personal information regarding the consumer (e.g., the consumer's email address, name or telephone number) and may include pictures, drawings, photos, links, and/or audio attachments.

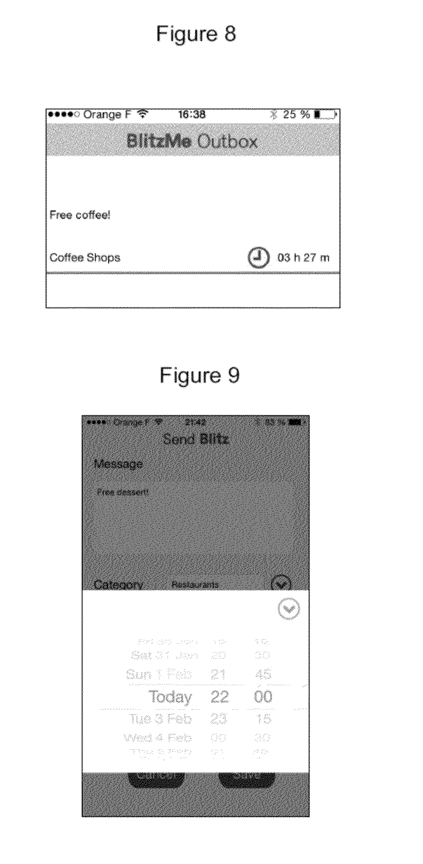

Upon submitting the offer to the server, the offer is available for viewing in a list such as an “Outbox” as shown in the example shown in FIG. 8. In a preferred embodiment, this interface offers control capabilities to delete offers from the list (which, consequently, causes the offers to be removed from the server and made unavailable to consumers) and/or make edits to one or more parameters of one or more offers.

It may be noted in FIG. 7 that the field “Post at” has the corresponding value “Now”, which in a preferred embodiment of the invention would be the default setting. This is intended to indicate that the offer is to be made valid and published at the moment the vendor submits the offer by activating the “Save” button. Alternatively, however, the vendor may choose to have publication of the offer delayed by a period of time, such that the offer is not valid and not made available to consumers until some time in the future. An example embodiment of this feature is shown in FIG. 9, showing an example interface wherein another offer “Free dessert!” is being made by the vendor and a selection of a date and time is being made via a suitable user interface to indicate when the server should publish the offer and thus make the offer available to consumers.

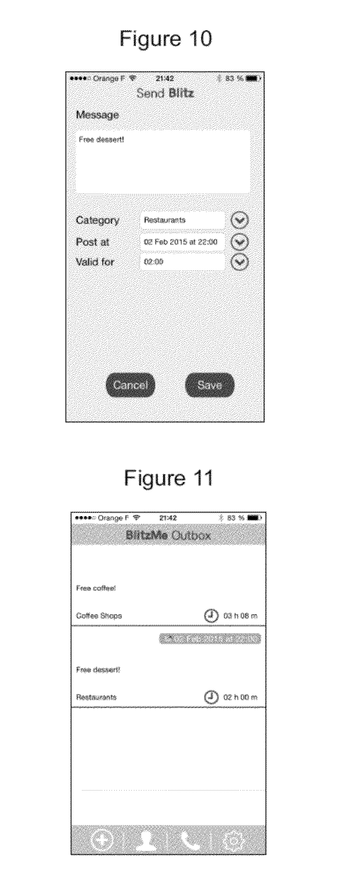

The resulting offer message package is shown in the example illustrated by FIG. 10.

The above example of preparing the offer message package is a non-limiting example.

The time in the box here labeled “Post at” indicates when the offer message will be published (in this example, 2 Feb. 2015 at 22:00). As in the previous example, the vendor completes the process by pressing the “Save” button. In this example, once this offer is submitted to the server s1, the vendor's Outbox screen would appear as in FIG. 11 listing each of the offers published or publishable on the server s1. Again, in a preferred embodiment, the vendor can operate this interface to delete or edit the offers presented in this list.

At the server s1, the offer message package is received from the vendor's computer device vc1 and stored in a non-volatile memory of the server s1 (Step 106). In a preferred embodiment of the invention, the vendor's computer device vc1 displays a screen such as in FIG. 8 showing that the offer package has been accepted by the server s1. The vendor can submit, and the server s1 can store, a plurality of different offers, whereupon the vendor's computer device vc1 might display a screen such as shown in FIG. 9 listing each offer stored for the vendor v1 by the server s1.

Beginning at the selected publish time and for the selected time period, the server s1 copies or moves the offer message of the received offer message package to a compilation of published offer messages hosted on the system server (Step 108). Offer messages within the compilation of published offer messages are available to be retrieved by consumers from the server s1, as will be further detailed below. Further upon expiration of the selected time period, the server s1 removes the offer message from the compilation of published offer messages (Step 110), thereby making the offer message unavailable for retrieval by consumers.

The invention is not limited to the foregoing steps of the server s1 for storing and managing offer messages.

For example, as a non-limiting alternative arrangement, the server s1 can maintain all offer messages in a single database or table. A determination of whether any particular offer message is published can take place upon querying the database or table, whereupon the current time is compared with the time information stored in the database or table with the offer message for expiration of the offer. Where the result of this test shows that the offer has expired, the offer is not retrieved for delivery to the consumer.

Further if the vendor wishes to rescind the promotion offer, the vendor can delete a published offer message by deleting the offer as above, and the offer message will immediately be removed from the system server (and all consumers' devices, if already published).

Further in accordance with the instant example, consumers communicate with the system using either of a dedicated consumers-application or via a browser, similarly to how vendors connect as indicated above. A particularly advantageous feature of the invention, however, is that consumers need not authenticate with the server s1 or otherwise provide personal information to the server s1 in order to proceed with the invention.

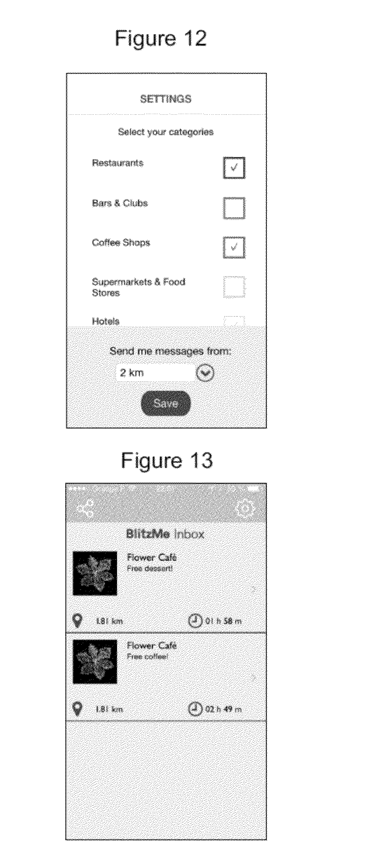

In the instant example, a consumer interacts with the server s1 by preparing and transmitting search information, including one or more desired subject categories (e.g., coffee shops) and a search distance. A non-limiting example interface for selecting this search information is shown in FIG. 12, providing a selectable list of category items and a field for selecting a valid distance from the consumer's current location to any potential vendors. In a preferred embodiment, the search information also includes a current geographical location of the consumer, determined in any of a number of conventional ways, e.g., automatically by a GPS or other automatic geolocation-determining feature of a smart phone or other portable device, by selection of a map that determines and displays the consumer's location, or by manual input by the consumer.

The consumer can select a search distance in a number of ways, e.g., by numeric entry or by indicating a distance on the displayed map. The consumer also selects one or more subject categories, e.g. with a screen as shown in FIG. 12. These consumer selections give the system server s1 a distance proximity parameter and a category parameter to select appropriate offer messages for display to the consumer. Once all this search information is selected and set to the satisfaction of the consumer, the consumer actuates a control on the device that causes the device to send the search information to the server s1 (step 200).

Upon receiving the search information from the computer device of the consumer, the inventive system responds by determining which published offer messages satisfy the consumer's distance proximity parameter (geographic proximity) and the category parameter. Published offer messages determined to satisfy both the distance proximity parameter (geographic proximity) and the category parameter are forwarded to the consumer's device (step 204) for display. An exemplary interface for listing the valid offer messages is shown in FIGS. 13 and 16. In this preferred example, each valid offer is shown with indicators for a distance for travelling to the vendor and a time indicating how long each offer remains available.

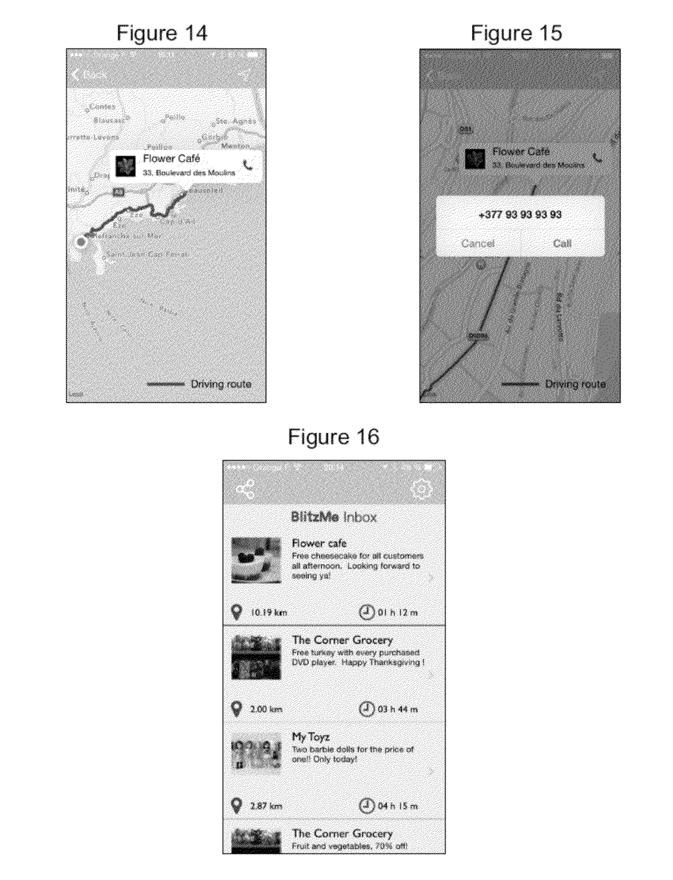

In a particularly preferred embodiment, the consumer c1 may actuate a user-interface control on the interface (for example, at or near an indicator of distance) and the device will respond by presenting a map that shows the location of the corresponding vendor and, more preferably, a route from the current location of the consumer c1 to the vendor (e.g., FIG. 14). In a further preferred embodiment, actuation of another user-interface element causes the device to initiate a call to the corresponding vendor (e.g., FIG. 15).

In the event that no published offers meet the consumer's search criteria, the server s1 sends a message to the consumer's device that no results satisfying the search criteria were found (Step 202).

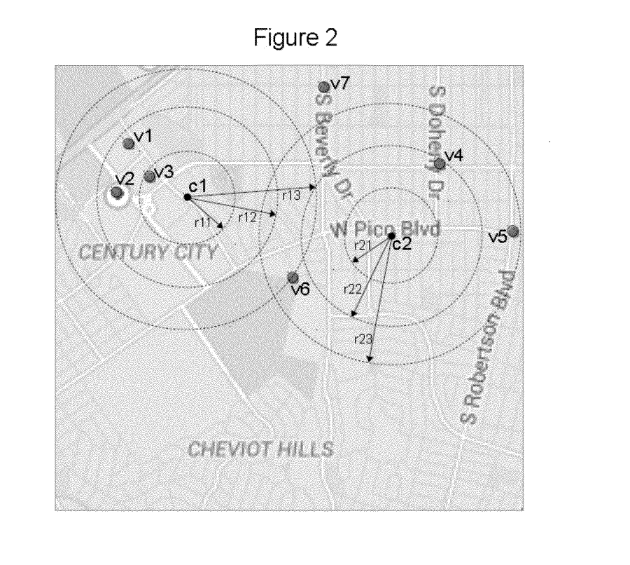

For example, in FIG. 2, consumers c1 and c2 are shown in an area within proximity of vendors v1 to v7. In this example, each of the vendors v1 to v7 use the invention to publish offers on the server s1. Server s1 is not shown in FIG. 2 because, as server s1 is connected to each of the computer devices vc1 to vc7 of the vendors by way of the Internet, server s1 need no be in close proximity to any of the geographical locations of vendors v1 to v7.

In the example shown in FIG. 2, vendor v3 is within a distance r11 to computing device of consumer c1, whereas vendors v1 and v2 are within a second distance r12 to consumer c1.

Vendor v6 is just inside the third distance r13 to consumer c1, whereas vendors v4, v5, and v7 are beyond this third distance r13.

In accordance with this example, each of the vendors v1 . . . v7 are coffee shops, each vendor v1 . . . v7 have used their respective computer devices to interact with the server s1 to publish an offer for free coffee. Assuming that none of these offers have expired or been rescinded by a respective vendor, then each of the offers are eligible to being sent to one or both of consumers c1 and/or c2.

In accordance with this example, whether any of consumers c1 or c2 will see any of the offers published by vendors v1 . . . v7 depends on the search information sent to the server s1 by the respective consumer. Assuming that both consumers c1 and c2 select a subject category corresponding to “coffee shop”, the result will depend on the search distance included in the search information.

With a search information transmitted from consumer c1, a geographical position of the consumer c1's computer device is also sent to the server s1. The server s1 uses this information and the information stored for each vendor v1 . . . v7 of the published offers to determine whether each vendor v1 . . . v7 is within the search distance transmitted by the consumer.

Thus, if the consumer c1 transmits search information to the server s1 corresponding to a “coffee shop” and a search distance of r11, then the server s1 will respond with the published offer from vendor v3, but not any of v1, v2, or v4 . . . v7. On the other hand, if the consumer c1 transmits search information corresponding to a “coffee shop” and a search distance of r13, the server will respond with published offers from each of vendors v1 . . . v3 and v6, but not v4, v5, and v7.

On the other hand, the consumer c2 will see different results because the geolocation device in his computer device sends different geolocation information to the server s1 than that of consumer c1. Thus, if the consumer c2, for example, transmits search information corresponding to a “coffee shop” and a search distance of r23, the server will respond with published offers from each of vendors v4 . . . v6 and v6, but none of v1 . . . v3 or v7. If the consumer c2 transmits search information corresponding to a “coffee shop” and a search distance of r13, the server will respond with no published offers, because none of vendors v1 . . . v7 satisfy consumer c2's search distance.

In each of these cases, the consumer carries out an anonymous search of published offer messages based on geographic proximity of the consumer with respect to the vendor and subject category. Based solely on a category of good or service desired, a desired travel distance, and a current geographical position that is preferably automatically provided by the consumer's computing device, the consumer retrieves any available offers published by respective vendors within the desired distance that may provide the desired good or service. On the other hand, each vendor controls the text of any offer as well as when and for how long the offer remains available to be retrieved by a consumer. With these features, the invention provides an efficient system for vendors to make available offers to consumers that are both in search of the good or service they offer and within a distance they are prepared to travel, all while requiring little effort from the consumer except to connect to the server s1 and provide the search information.

The published message offers sent by the server to the consumer may include pictures, drawings, photos, links, and/or audio attachments.

In the preceding description, for purposes of explanation, numerous details are set forth in order to provide a thorough understanding of the embodiments of the present invention. However, it will be apparent to one skilled in the art that these specific details are not required in order to practice the present invention.

The invention as described herein may comprise one, several, all, or any of the embodiments provided above in any combination. The above-described embodiments of the present invention are intended to be examples only. Alterations, modifications and variations can be effected to the particular embodiments by those of skill in the art without departing from the scope of the invention, which is defined solely by the claims appended hereto.

1. A method providing ad hoc offer messages and anonymous geographic proximity and category searches, comprising the steps of:
a geographically located vendor, via a vendor computer device, preparing an offer message package by i) inputting an offer message describing an offer of a product or service being made by the vendor, ii) placing the offer message within an appropriate subject category by selecting one subject category, from a selection of plural subject categories, that describes the product or service being offered by the vendor, iii) selecting a time period for publishing the offer message, iv) selecting a publish time for beginning the publishing of the offer message, the selected publish time being one of a) immediately and b) a specific time at which the offer message will be published, and v) executing a send command that transmits the offer message package to a system server, the system server operatively connected to the vendor computer device via a communication network, the offer message package comprising the offer message, the selected subject category, the selected time period for publishing the offer message, and the publish time for beginning the publishing of the offer message;
the system server receiving, via the network, the offer message package sent from the vendor computer device and, beginning at the selected publish time and for the selected time period, adding the offer message of the received offer message package to a compilation of published offer messages hosted on the system server, the system server removing the offer message from the compilation of published offer messages upon expiration of the selected time period;
a consumer, via a consumer computer device operatively connected to the system server via the network, i) selecting a search distance from a group of search distances, and ii) selecting, a desired subject category to be searched, from the selection of plural subject categories, that describes a product or a service desired by the consumer, and iii) executing a search command that transmits the selected search distance, the selected desired subject category, and a location of the consumer computer device to the system server;
the system server i) using the selected search distance and the location of the consumer computer device to determine a geographic search region, ii) using the selected desired subject category and the determined geographic search region to search the compilation of published offer messages hosted on the system server for a set of published offer messages that satisfies the determined geographic search region and the selected subject category, and iii) transmitting the set of published offer messages that satisfies the determined geographic search region and the selected desired subject category to the consumer computer device; and
displaying, on the consumer computer device, the transmitted set of published offer messages that satisfies the determined geographic search region and the selected desired subject category.

2. The method of claim 1, wherein,
the vendor computer device is any of a smart phone, an network-connected tablet, or a network-connected personal computer, and
the consumer computer device is another smart phone, network-connected tablet, or network-connected personal computer.

3. The method of claim 1, wherein the consumer selects the search distance from a group of search distances comprising ¼ mile, ½ mile, 1 mile, 5 miles, 50 miles, and 100 miles.

4. The method of claim 1, wherein the consumer selects the search distance from the group of search distances including the consumer inputting an ad hoc distance.

5. The method of claim 1, wherein the subject category is selected from a group comprising restaurants, cinemas, clothing stores, hotels, bakeries, and supermarkets.

6. The method of claim 1, wherein in said step of the consumer selecting the desired subject category to be searched from the selection of plural subject categories, the consumer selects plural desired subject categories to be searched.

7. The method of claim 1, wherein the selected publish time of the offer message is immediate upon transmitting the offer message package to the system server.

8. The method of claim 1, wherein the selected publish time of the offer message is at i) a specified future time, or ii) a specified future date and time.

9. The method of claim 1, comprising the further steps of:
the vendor, via the vendor computer device, edits the published message located within the compilation of published offer messages hosted on the system server to change any feature of the published offer message to thereby form an updated offer message; and
the system server sending the consumer the updated message offer as a refresh update.

10. The method of claim 1, wherein when the vendor removes the received offer message from the compilation of published offer messages, the removed offer message is immediately deleted from the consumer device.

11. The method of claim 1, further comprising:
the vendor, via the vendor computer device, selecting a offer message package, having a future publish time, to be deleted, and transmitting a delete message to the server identifying the offer message to be deleted, and
whereupon the server, upon receiving the delete message transmitted from the vendor computer device, removes the offer message to be deleted, from the system server.

12. The method of claim 1, comprising the further step of the consumer deleting individual published offer messages from the consumer computer device.

13. The method of claim 1, wherein the location of the consumer computer device is determined automatically by retrieving location information from a geolocation device in connection with the consumer computer device.

14. The method of claim 13, wherein the geolocation device is a global positioning satellite (GPS) device incorporated with the consumer computer device.

15. The method of claim 1, wherein the location of the consumer computer device is determined manually by consumer input in the consumer computer device.

16. The method of claim 1, wherein the published message offers from the vendor, sent by the system server, to the consumers includes at least one of pictures, drawings, photos, links and audio attachments.

17. A non-transitory computer readable medium having stored thereon a computer executable code assembled as a computer program that, upon execution on a computer server, causes the computer server to perform a method of publishing and transmitting ad hoc offer messages and anonymous geographic proximity and category searches, as recited in claim 1.

18. A non-transitory computer readable medium having stored thereon a computer executable code assembled as a computer program that, upon execution on a network-connected computer server, causes the computer server to perform a method of publishing and transmitting ad hoc offer messages and anonymous geographic proximity and category searches, the method comprising the steps of:
making available one or more ports on one or more network interfaces of the computer server operatively connected to one or more networks for receiving communications from i) a network-connected vendor computer device of a geographically located vendor and ii) a network-connected consumer computer device;
receiving from the vendor computer device, via any of the one or more networks, an offer message package comprising an offer message, a selected subject category that describes a product or service being offered by the vendor, a selected time period for publishing the offer message, and a publish time for beginning the publishing of the offer message, the selected publish time being one of a) immediately and b) a specific time at which the offer message will be published;
beginning at the selected publish time and for the selected time period, adding the offer message of the received offer message package to a compilation of published offer messages hosted on the computer server;
removing the offer message from the compilation of published offer messages upon expiration of the selected time period;
receiving from the consumer computer device, via any of the one or more networks, a search command that includes a consumer-selected search distance, one or more consumer-selected desired subject categories, and a location of the consumer computer device;
using the consumer-selected search distance and the location of the consumer computer device to determine a geographic search region;
using the consumer-selected desired subject category or categories and the determined geographic search region to search the compilation of published offer messages hosted on the server for a set of published offer messages that satisfies the determined geographic search region and the selected subject category or categories; and
transmitting the set of published offer messages that satisfies the determined geographic search region and the selected desired subject category to the consumer computer device to be displayed on the consumer computer device.
